(19) United States
(12) Patent Application Publication
(10) Pub. No.: US 2025/0291824 A1
(43) Pub. Date: Sep. 18, 2025

(54) A System and Method for Providing Interactive Content of a Living Room Device

(71) Applicant: GLANCEINMOBI PTE.LIMITED

(72) Inventors: Karthik Sai Marala, Karnataka (IN); Tarun Anchala, Pradesh (IN); K.V. Nanja Urs, Karnataka (IN); Manish Kumar Gupta, Karnataka (IN)

(73) Assignee: GLANCEINMOBI PTE.LIMITED, (omitted)

(21) Appl. No.: 19/070,532

(22) Filed: Mar. 5, 2025

(30) Foreign Application Priority Data
Mar. 12, 2024 (IN) 202411017617

(51) Int. Cl. G06F 16/3329; G06F 16/335

(52) U.S. Cl. CPC G06F 16/33295; G06F 16/335

(57) ABSTRACT

System and method for generating one or more interactive responses for a computing device, said system comprising at least one processing unit connected to a memory. The method comprises generating one or more prompts to be displayed at the computing device. Thereafter, the method comprises receiving in real time one or more input queries from the at least one computing device. The method further comprises identifying one or more interactive attributes based on the one or more input queries and the one or more prompts. Lastly, one or more responses are generated to the one or more input queries and displayed at the display unit of the at least one computing device.

### TECHNICAL FIELD

The invention of the present disclosure relates to the field of interactive user engagement on a computing device. More specifically, the invention of the present disclosure relates to generating interactive responses for computing device, like a living room device.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the overall field of the invention, and not as admissions of prior art.

The recent advancements in generative artificial intelligence (AI) technologies have opened doors for the introduction of AI into many domains of consumer electronics, such as mobile phones, searching and learning, automated workflows etc. However, the current media devices in the state of the art are yet to take advantage of the integration of AI and other user-engagement technologies to develop an active and interactive form of content consumption.

Interactive Television (ITV) refers to a technology that engages viewers with television content and provides two-way communication between the viewer and the TV. ITV also offers various additional features, including the ability to participate in polls, access video-on-demand services, and utilize electronic program guides. ITV is based on artificial intelligence (AI) technology and represents a groundbreaking advancement in the realm of television entertainment. Conventional television has been a one-way communication medium, where viewers passively consume content without active participation. However, the integration of AI technology into television platforms provides a more interactive and engaging experience for viewers.

For example, currently televisions, which are one of the most popular and commonly used devices for media consumption, only offer a passive form of user-interaction with the on-screen content. This interaction may be in terms of basic actions such as liking or disliking available content on a media platform or the ability to view the viewing metrics or other associated trends with a piece of content. Despite advancements in ITV, the current state fails to provide an engaging and two-way conversational experience for viewers. Though many types of ITV are available in the market, viewers are still unable to interact with TV content effectively, as ITV systems are not able to properly comprehend and respond to the diverse range of queries and comments provided by viewers in real time. Further, currently available ITV systems also fail to handle dynamic and unpredictable conversational scenarios.

Moreover, the content presented on ITV is inherently diverse and constantly changing, ranging from news updates to sports events to scripted dramas, due to which currently available ITV systems also struggle to keep pace with the rapid flow of information and adjust their responses, accordingly, resulting in a disjointed and unsatisfactory interaction for viewers. One significant challenge faced by ITV is ensuring effective communication across multiple languages. As television audiences are increasingly diverse, accommodating various languages and dialects becomes crucial to providing an inclusive and accessible experience for all viewers.

Certain conventional solutions to the problem of lack of user engagement and interactivity with the content involve the integration of basic chatbots or assistants into the media devices. However, these solutions are limited by their own set of drawbacks. For example, more often than not, these functionalities are only available in a set of limited languages and therefore may not be accessible to a diverse range of individuals. Furthermore, the functionalities of these chatbots or assistants is limited to IOT control over connected appliances, that is often unrelated to the actual on-screen content itself, or the automation of the most basic tasks such as play, pause, volume control etc. Moreover, currently available ITV systems often overlook the crucial aspect of multi-lingual support when addressing user inquiries. This oversight results in various instances of misinterpretation or misunderstanding, especially evident when users with diverse accents attempt to engage with the ITV platform. The absence of accent support poses a significant challenge, as voice recognition struggles to accurately decipher commands or queries expressed in non-standard accents, leading to user frustration and diminished usability. This gap in multi-lingual support not only hampers the ITV's outreach but also undermines overall user satisfaction and engagement levels.

Hence, there is a need in the art for a system and method that may be able to leverage technological advancements in context of user-engagement technologies to facilitate an active interaction between a user of a media device and the on-screen contents.

### OBJECTS OF THE DISCLOSURE

This section is provided to introduce certain aspects of the present disclosure in a simplified form that are further described below in the detailed description. This summary is not intended to identify the key features or the scope of the claimed subject matter.

In order to overcome at least a few of the problems of the known solutions as provided in the previous section, an objective of the present disclosure is to substantially reduce the limitations and/or drawbacks of the prior arts as described herein above.

Another objective of the present disclosure is to increase user-engagement and interactivity with on-screen contents on media devices.

Yet another objective of the present disclosure is to increase accessibility to content on media devices via real-time multilingual translation and captioning support.

Yet another object of the invention is to provide a system and method for maintaining contextual language preferences-based engagement with the viewer and providing contextual conversational interactivity.

Yet another objective of the present disclosure is to provide a system and method that incorporates one or more artificial intelligence (AI) based assistant functions that improve user-engagement and cater to individual user interests.

Yet another object of the invention is to provide a system and method that integrated one or more advanced AI models for enhancing an engagement with the content, thereby shifting the experience from passive viewing to active engagement.

### SUMMARY

This section is provided to introduce certain aspects of the present disclosure in a simplified form that are further described below in the detailed description. This summary is not intended to identify the key features or the scope of the claimed subject matter.

An aspect of the present disclosure relates to a method for generating one or more interactive responses for at least one computing device. The method comprises generating, by a processing unit, one or more prompts for the at least one computing device. The method further comprises displaying, by a processing unit, the one or more prompts on a display unit of the at least one computing device. Thereafter, the method comprises receiving in real time, by a processing unit, one or more input queries from the at least one computing device. The method further comprises identifying, by the processing unit, one or more interactive attributes based on one of the one or more input queries and the one or more prompts, and thereafter generating dynamically, by the processing unit, one or more responses to the one or more input queries based on the one or more attributes. Thereafter, the method comprises displaying, by the processing unit, the one or more responses at the display unit of the at least one computing device.

In an exemplary aspect of the present disclosure, the method further comprises displaying the one or more prompts in one or more languages on the display unit of the at least one computing device.

In an exemplary aspect of the present disclosure, the method further comprises generating the one or more prompts based on at least one of a user preference and one or more contents being presented at the display unit of the at least one computing device.

In an exemplary aspect of the present disclosure, the method further comprises receiving, at the processing unit, a selection from the at least one computing device from the one or more prompts displayed at the display unit of the at least one computing device wherein the one or more attributes are identified based on an analysis of the received selection for the one or more prompts.

In an exemplary aspect of the present disclosure, the one or more interactive attributes may comprise a language, an accent and one or more tasks associated with the one or more input queries.

In an exemplary aspect of the present disclosure, the method further comprises transmitting, by the processing unit, the one or more interactive attributes to an intelligent interaction unit connected with a multilingual repository, and wherein the intelligent interaction unit generates the one or more responses.

Another aspect of the present disclosure relates to a system for generating interactive responses for at least one computing device, the system comprising a processing unit that is configured to generate one or more prompts for the at least one computing device and display the one or more prompts on a display unit of the at least one computing device. The processing unit is further configured to receive one or more input queries from the at least one computing device. The processing unit is further configured to identify one or more interactive attributes based on one of the one or more input queries and the one or more prompts, and thereafter generate dynamically one or more responses to the one or more input queries based on the one or more attributes. Additionally, the processing unit is further configured to display the one or more responses at the display unit of the at least one computing device.

Yet another aspect of the present disclosure may relate to a non-transitory computer readable storage medium storing instructions for generating interactive responses for at least one computing device, the instructions include executable code which, when executed by one or more units of a system, cause a processing unit of the system to generate one or more prompts for the at least one computing device and display the one or more prompts on a display unit of the at least one computing device. The instructions when executed by the system further cause the processing unit of the system to receive one or more input queries from the at least one computing device. The instructions when executed by the system further cause the processing unit of the system to identify one or more interactive attributes based on one of the one or more input queries and the one or more prompts, and thereafter generate dynamically one or more responses to the one or more input queries based on the one or more attributes. Additionally, the instructions when executed by the system further cause the processing unit of the system to display the one or more responses at the display unit of the at least one computing device.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Also, the embodiments shown in the figures are not to be construed as limiting the disclosure, but the possible variants of the method and system according to the disclosure are illustrated herein to highlight the advantages of the disclosure. It will be appreciated by those skilled in the art that disclosure of such drawings includes disclosure of electrical components or circuitry commonly used to implement such components.

FIG. 1 illustrates a method for generating one or more interactive responses for at least one computing device, in accordance with an exemplary implementation of the present disclosure.

FIG. 2 illustrates a high-level functional block diagram of a system for generating one or more interactive responses, in accordance with an exemplary implementation of the present disclosure.

FIG. 3 illustrates a high-level block diagram for the processing of the one or more input queries in an intelligent interaction unit for the generation of one or more interactive responses, in accordance with an exemplary implementation of the present disclosure.

FIG. 4A illustrates the display of one or more prompts overlayed over a portion of the content being displayed on computing device of a user, in accordance with an exemplary implementation of the present disclosure.

FIG. 4B illustrates a conversational interaction between the user and the intelligent interaction service, based on the selection of one or more prompts, reception of one or more input queries and the generation of the one or more responses, in accordance with an exemplary implementation of the present disclosure.

### DETAILED DESCRIPTION

In the following description, for the purposes of explanation, various specific details are set forth in order to provide a thorough understanding of the embodiments of the present disclosure. It will be apparent, however, that embodiments of the present disclosure may be practiced without these specific details. Several features described hereafter may each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The invention of the present disclosure relates to a solution to generate interactive responses for at least one computing device to increase user engagement and interactivity of a user with the on-screen content. The solution of the present disclosure intelligently incorporates an intelligent approach to dynamically generate, in real-time, one or more interactive responses to interact with a user by identifying one or more attributes associated with a user to individualise the interaction of the user with the on-screen content. The solution of the present disclosure further incorporates a dynamic prompt generation mechanism to gauge user preferences while making available the enhanced user-engagement and interactivity features in a multi-lingual format that takes into account the native accents to increase accessibility of one or more contents for a diverse range of users. The solution of the present disclosure further incorporates artificial intelligence supported mechanisms to integrate advanced assistant-based functions into the experience of content consumption for a user to enable individualised content-based interactions thereby elevating the conventional passive experience of interacting with content on computing devices to an active and interactive experience.

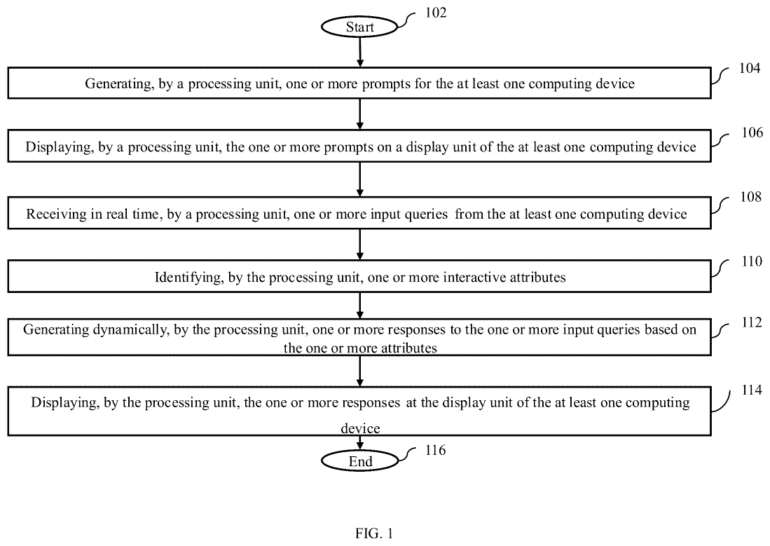

FIG. 1 of the present disclosure illustrates a method [100] for generating one or more interactive responses for at least one computing device (hereinafter referred to as “computing device”), in accordance with an exemplary implementation of the present disclosure. As shown, the method [100] for generating one or more interactive responses for at least one computing device commences at step [102].

Thereafter, at step [104], the method comprises generating, by a processing unit, one or more prompts for a computing device. The one or more prompts, as used herein may include, but are not limited to, one or more of a question, a suggestion, a call for an action and/or an interactive element.

In one implementation, the generation of the one or more prompts may be based upon at least one of a user preference and one or more content that are being presented on the display unit of the computing device. Additionally, in another implementation, the one or more prompts may be further based on one or more related contents that have been previously viewed by the user.

As used herein, the user preference may comprise a set of parameters that may be stored in the storage unit of a computing device, any or each of which may be generated and stored based on the prior interactions of a user with one or more contents stored, viewed, hosted, streamed or downloaded on the computing device. Additionally, in one implementation the user preference may further comprise one or more prior interactions of a user, via the computing device, with the one or more prompts that may have been generated and presented to the user at a previous instance. Accordingly, the set of parameters stored as user preference may include, but are not limited to a preference of language for audio or captions associated with one or more content watched by the user, a genre of content, typical length of content, usage patterns for one or more services enabled by the computing device, content viewing patterns etc.

Further, the one or more content being displayed on a display unit of the computing device may comprise different mediums, including but not limited to, a movie, a picture, a document, a webpage, a blog, an application and/or a text. Additionally, in one implementation, the one or more content may further comprise an audio, such as music or recordings that may be supplemented by one or more visual cues on the display unit of the computing device. Such visual cues may include a graphical visualisation, a cover art, a music video, a dynamic display of captions corresponding to the audio etc.

In one implementation, the generation of the one or more prompts may comprise analysing the one or more content as illustrated above to extract one or more features associated with the content being displayed on the computing device. For example, in case of a movie, at least a portion of the audio associated with the content may be processed using a speech-to-text model, thereby generating a textual backdrop of the on-going portion of the movie-based content, and thereafter, specific features and/or events may be identified from the converted text that may be relevant to the user at the specific instance when the one or more prompts may be generated. Thereafter, the extracted features may be processed in conjunction with one or more user preferences stored in the computing device, wherein the one or more preferences may be used to perform at least one of the following, namely, generate additional prompts to be presented to the user, refining the one or more prompts already generated and/or eliminating at least one prompt from the one or more prompts that may be inconsistent with the stored user preference.

Thereafter, at step [106], the method comprises displaying, by a processing unit, the one or more prompts on a display unit of the computing device. Further, in one implementation, the displaying of the one or more prompts may comprise displaying the one or more prompts in a plurality of languages. Each of the plurality of languages in which the one or more prompts may be displayed may be determined at step [104] on the basis of the stored user preferences.

Further, in one implementation, the one or more prompts may be displayed as an overlay that may be superimposed over and above a portion of the one or more contents that are being displayed on the computing device, in real-time. Alternatively, the one or more prompts may be displayed in the form of a pop-up or a notification over the content. It may be understood that the above examples are merely for the purpose of illustration and not intended to limit the scope of the present disclosure, and as such the one or more prompts may also be displayed in any other manner as may be known to a person ordinarily skilled in the art.

For the purpose of ease of understanding, the above steps may be understood by way of an example wherein a user Mr. X is watching a documentary AW regarding aquatic wildlife on a television unit, i.e., the computing device. At one instance, wherein the documentary is discussing a unique specie of fishes, the generation of one or more prompts may include understanding the on-screen content, i.e., discussion on the specie of fish and retrieving the stored preferences of Mr. X, to generate prompts in the preferred languages of Mr. X, e.g., English, Hindi and Spanish. Here the one or more prompts may reflect one or more questions that may lead to the discovery of novel set of information associated with the specie of fish that is the focus of the on-going portion of the on-screen content. For illustration, the prompt may be a question such as “Can you please tell me about the migration patterns of fish species Y?”. After the one or more prompts are generated, they may be displayed on the television of Mr. X in three different languages, English, Hindi and Spanish.

Thereafter, at step [108], the method [100] comprises receiving in real time, by a processing unit, one or more input queries from the at least one computing device. As used herein, the one or more input queries may be provided, via the computing device on the basis of one or more user inputs. The one or more inputs may include, but are not limited to, a selection of the one or more prompts, a request for the performance of an action and one or more questions.

It may be understood by a person skilled in the art that the one or more input queries may include a selection of the one or more prompts displayed at step [106], however, the scope of input queries in the present disclosure is not limited only to such selection, and as such, the one or more input queries may also comprise inputs that are independent and in addition to the input queries corresponding to the selection of the one or more prompts. For example, in one scenario, a user may choose not to engage in the one or more prompts displayed at step [106], and instead provide an input query that may not be covered by the one or more prompts.

In addition to the process of generating one or more interactive responses, the one or more input queries may be used in addition to determine and store one or more user preferences.

Continuing with our previous example, Mr. X may select the prompt in English because of his interest in the migration patterns of the fish specie. Alternatively, Mr. X may desire to also learn about the origin of the concerned fish specie and therefore, Mr. X may further provide an additional input query in English. Further, the selection of the one or more prompts in English language out of the available options may be used as indicator of preferences of Mr. X.

Thereafter, at step [110], the method [100] comprises identifying, by the processing unit, one or more interactive attributes from the received queries and the one or more prompts. In one implementation, the identification of the one or more interactive attributes may be based upon an analysis of the one or more prompts selected by the user via the computing device. Alternatively, in another implementation, the one or more interactive attributes may be further identified from the analysis of one or more independent input queries that may be distinct from the selection of the one or more prompts.

As used herein, the one or more interactive attributes may include, but are not limited to the characteristic features of the one or more input queries that may indicate the requirement for the performance of one or more underlying tasks associated with the one or more input queries. The interactive attributes may define the mode of interaction requested by a user via the computing device. Additionally, in one implementation, the one or more interactive attributes may further comprise characteristic features of the one or more input queries that may indicate one or more preferences of the user, for example, the linguistic preferences of a user, including a language and an accent.

For example, wherein a user selects the one or more prompts displayed on the screen at step [108], the user is indicating a desire to interact via the performance of a task associated with the selected prompt, such as receiving a response to a query relating to the on-screen content. Similarly, an independent input query requesting for a list of available contents for purchase within a pre-defined price range may comprise multiple interactive attributes such as a look-up request for a set of desired content, a filtering request to derive the content within the desire price range etc.

Furthermore, the identification of interactive attributes may also comprise associating a user preference with the probable desired outcomes for the user. To illustrate, let us continue with our on-going example. Mr. X has selected the “Can you please tell me about the migration patterns of specie X?”. Additionally, Mr. X has also provided an independent query in addition to the selected prompt, i.e., “Can you please recommend to me a good book to study about specie X and related aquatic wildlife?” Here, the identification of interactive attributes may comprise identifying a preference of Mr. X for the English language by his selection of the prompt. It may further comprise the identification of attributes relating to data on the migration patterns of specie X and resource material for the study of associated topics.

Thereafter, at step [112] the method comprises generating dynamically, by the processing unit, one or more responses to the one or more input queries based on the one or more attributes. As used herein, the one or more responses may be interactive responses that may comprise a plurality of actions associated with the one or more input queries received. In one implementation, a plurality of identified interactive attributes may be combined to generate a single interactive response. In application, the one or more responses may include, but are not limited to, changing a playback language, generated real-time multi-lingual captions based on user preferences, navigating one or more sets of data to generate a query response, performance of one or more assistive interface actions and redirecting the user to a second set of content

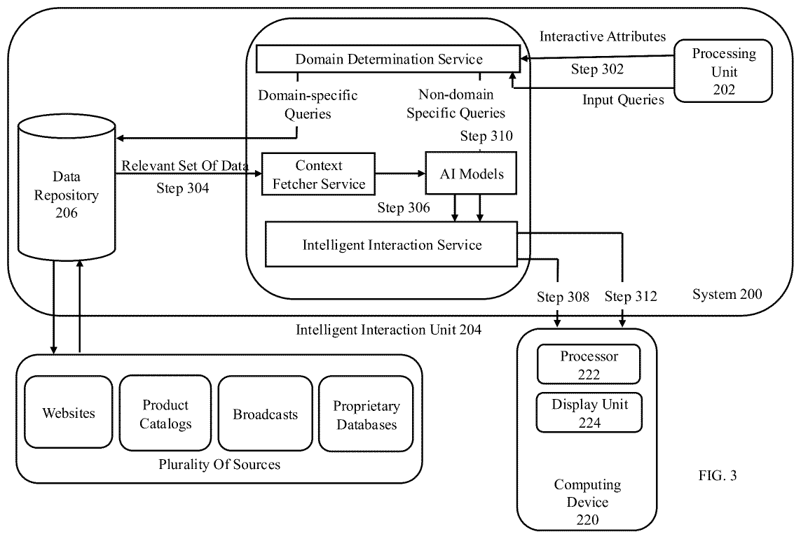

Further, in one implementation, the generation of the one or more responses may be performed by a processing unit, via an intelligent interaction unit. The intelligent interaction unit may comprise one or more artificial intelligence (AI) models for generating the one or more responses. In another implementation, the method [100] may comprise the intelligence unit retrieving one or more sets of data from a connected data repository for the generation of the one or more interactive responses. The same is discussed in further detail later in conjunction with FIG. 3. The method comprises transmitting, by the processing unit, the one or more interactive attributes to an intelligent interaction unit connected with a multilingual repository, and wherein the intelligent interaction unit generates the one or more responses.

In yet another implementation, the method [100] may further comprise updating the intelligent interaction unit based on the generation of the one or more responses. Parallel update of the intelligence interaction unit may be used to provide a highly individualized experience for the user in subsequent interactions based on adaptation parameters implemented. This may include training the one or more artificial intelligence (AI) models associated with the intelligence interaction module to create a constant adaptation loop. The updating action may further comprise updating the data repository associated with the intelligent interaction unit with the latest available sets of data.

Thereafter, at step [114] the method comprises displaying, by the processing unit, the one or more responses at the display unit of the at least one computing device. Thereafter, the method terminates at step [116].

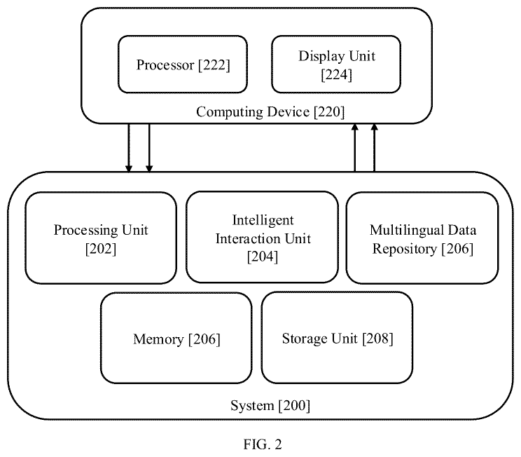

FIG. 2 shows a high-level functional block diagram of a system [200] for generating one or more interactive responses for at least one computing device. As shown in FIG. 2, the system [200] comprises at least one of each of the following elements, namely, a processing unit [202], an intelligent interaction unit [204], a data repository [206], a memory unit [208] and a storage unit [210]. It may be noted that the depiction in FIG. 2, shows one instance of each unit in the implementation of system [200], however, it may be understood that the same is for the purpose of illustration only and not to limit the scope of the present disclosure. As such, the system [200] may comprise more than a single instance of each unit in its possible implementations. As shown, the system [200] may be connected to at least one computing device [220] (hereinafter referred to as “computing device”).

Further, in one implementation, the system [200] may reside on a server that may be connected and in communication with a computing device [220]. The server may be connected with the computing device [220] via remote connection using one or more of wireless communication technologies as may be known by a person ordinarily skilled in the art. For example, the system [200] residing on a server may be in communication with the computing device over a wide area network (WAN) such as the internet, wherein the at least one computing device may be configured to connect via one or more of technologies for implementation of WANs, such as Wi-Fi, Li-Fi, 5G, 4G etc. Alternatively, in one implementation, the computing device may be connected with system [200] over a local area network (LAN).

In another implementation, the connection between the system [200] residing on a server and the computing device may be facilitated via one or more wired connection technologies as may be known by a person skilled in the art. For example, the connection may be based on the use of ethernet technology. Alternatively, in one implementation, the system [200] may be implemented natively on the computing device itself.

As used herein, the computing device may be any electronic device comprising at least one processor [222] and at least one display unit [224], that may be used to view one more content by a user. For example, the computing device may include, but is not limited to, a television, a personal computer such as a laptop, a tablet, a monitor, a smartwatch etc. Furthermore, the computing device may be configured to take inputs via a plurality of mediums, including but not limited to, textual inputs, auditory/speech-based inputs, gestures and/or the use of one or more input devices such as a keyboard or a joystick. Each of the inputs received by the computing device [520] may be transmitted to the system [500] in the form of input queries.

In operation, the system [200] may be configured to generate one or more prompts for the computing device [220] via the processing unit [202]. The one or more prompts generated by the system [200] may include, but are not limited to, one or more of a question, a suggestion, a call for an action and/or an interactive element.

In one implementation, the generation of the one or more prompts may be based upon at least one of a user preference and one or more contents that are being presented on the display unit [224] of the computing device [220]. Additionally, the one or more prompts may be further based on one or more related contents that have been previously viewed by the user.

As used herein, the user preference may comprise a set of parameters that are stored in the storage unit [210] of the system [200], any or each of which may be generated and stored based on the prior interactions of a user with one or more contents stored, viewed, hosted, streamed or downloaded on the computing device [220]. The user preferences may also include the one or more prior interactions of a user, via the computing device, with prior instances of one or more prompts generated by the system [200].

In another implementation, the system [200] may be further configured to generate the one or more prompts in a plurality of languages.

Thereafter, the system [200] may be configured to display the one or more prompts on a display unit [224] of the computing device [220]. In one implementation, the generated prompts may be displayed in a plurality of languages, wherein a user may be free to select a prompt in one of the plurality of languages based on preference.

The system [200] may be further configured to receive one or more input queries from the computing device [220]. An input query may be an input of the user provided via the computing device [220], wherein the input queries may be associated with the selection input of the user for the one or more prompts, or an independent and/or additional input that may be provided by a user apart from the selection of the one or more prompts.

The system [200] may be further configured to identify one or more interactive attributes upon the reception of the one or more input queries and the one or more prompts. In one implementation, the identification of the one or more interactive attributes may be based upon an analysis of the one or more input queries associated with the selection of the one or more prompts selected by the user. Alternatively, in one implementation, the identification of the one or more interactive outputs may be based upon both the input queries associated with a selection of one or more prompts by the user and one or more input queries that may be independent or in addition to the selection of the one or more prompts.

In one implementation, the one or more interactive attributes may comprise characteristic features of the one or more input queries that may indicate one or more preferences of the user, for example, the linguistic preferences of a user, including a language and an accent. Additionally, in another implementation, the one or more interactive attributes may further comprise characteristic features of the one or more input queries that may indicate the requirement for the performance of one or more underlying tasks associated with the one or more input queries.

Thereafter, the system [200] may be configured to dynamically generate, by the processing unit [220], one or more responses to the one or more input queries based on the one or more attributes, and thereafter, display the generated responses at the display unit [224] of the computing device [220].

In one implementation, the one or more responses may be generated by the processing unit [220], via the intelligent interaction unit [204]. Further, the intelligent interaction unit [220] may comprise one or more artificial intelligence (AI) models for generating the one or more responses.

In another implementation, the intelligence unit [204] may be connected to a data repository [206], wherein the intelligence unit [204] may be configured to retrieve one or more sets of data from the connected data repository [206] for the generation of the one or more interactive responses.

Another implementation of the system [200] may comprise updating the intelligent interaction unit [204], in real-time based on the generation of the one or more responses. This may include training the one or more artificial intelligence (AI) models associated with the intelligence interaction module to create a constant adaptation loop. The updating action may further comprise updating the data repository associated with the intelligent interaction unit with the latest available sets of data.

FIG. 3 illustrates a high-level schematic block diagram of the intelligent interaction unit for the generation [204] of one or more responses. As shown, at step [302] the intelligent interaction unit processes the one or more interactive attributes identified by the system [200], each of which may be associated with an input query. The identified interactive attributes may be based upon the input queries relating to the selection of the of the one or

more prompts generated by the system [200] and/or one or more input queries that may be independent to the selection of prompts, such as an input query provided by a user for the performance of one or more interactive assistant-based functions, such as a request to display weather information in the local area or a request for a meaning of a phrase from the on-screen content

Thereafter, at step [304], the intelligent interaction unit [204] segregates the one or more input queries into two categories, namely, domain-specific queries and non-domain-specific queries, based on the processing of the associated one or more interactive attributes. As used herein, a domain-specific query may comprise an input query the one or more interactive attributes of which may require access to specific domain knowledge of a subject-matter or a request.

For example, in one implementation, when a user requests for a list of products associated with a specific domain, such as a recent record of a favorite sportsman, the one or more interactive attributes of such input query may comprise characteristic features of an underlying task to present a set of data to the user. As such, a domain-specific input query may require the fetching and processing of one or more sets of data from one or more external sources.

On the other hand, a non-domain-specific input query may comprise an input query for which a response may be generated natively, by the intelligent interaction unit [304]. For example, in one implementation, wherein a preferred language of the user is determined to be a language other than the current playback language of the content on display of the computing device, the system [200] may change the language to a preferred language of playback for the user. Alternatively, wherein one or more input queries relate to a preference of language that may not be available, the system [200], via the intelligent interaction unit [204] may generate real-time, translated captions in the preferred language for the user. The generation of such responses may be performed natively via one or more AI models associated with the intelligent interaction unit [204], such as a large language model (LLM), thereby not requiring a domain-specific enquiry to generate a response.

In operation, upon segregation of the input queries, a domain-specific query, at step [304] the intelligent interaction unit [204] may, fetch, via a context fetching service, one or more relevant sets of data from the data repository [206] that is connected to the intelligent interaction unit [204].

For example, in one implementation, an input query may correspond to a request for purchasing a t-shirt associated with a preferred brand of the user. In this scenario, intelligent interaction unit [204] may determine the context and the domain associated with the request, to fetch a set of data from the data repository [206] comprising a list of listing for a t-shirt of the user's preferred brand at popular websites.

The data repository [206] may comprise a vector database that may be linked to a plurality of sources of data, wherein each source may be further associated with one or more domains. Further, the data repository may be configured to fetch one or more updated sets of data from the plurality of sources at a pre-configured threshold of duration.

In one implementation, the plurality of sources may include, but are not limited to, websites, product catalogs, broadcasts and proprietary databases associated with one or more domains. The data repository [206] may intelligently fetch, based on user preferences and prior input queries, one or more sets of data from such plurality of sources to maintain an updated database to provide an individualized interaction experience to the user. In another implementation, wherein, in an event a required set of data associated with a domain-specific query is determined to be absent from the data repository [206], the data repository [206] may be configured to fetch, in real-time, one or more updated sets of data from the plurality of sources.

Further, the data repository [206] may be a dynamic database, wherein it may determine, via the intelligent interaction unit [204] the relevancy of the existing sets of data in the repository. Accordingly, the data repository [206] may update or overwrite, in real-time, one or more redundant sets of data with an updated set of data.

Thereafter, at step [306], the intelligent interaction [204] unit may process the one or more sets of data fetched from the data repository [205] using one or more artificial intelligence (AI) models associated with the intelligent interaction unit [204] to generate the one or more responses.

At step [308], the one or more responses may be presented to the user on the display unit of the computing device via an interactive assistant service built into the intelligent interaction unit [204].

Alternatively, wherein, at step [302], an input query is determined to be a non- domain-specific query, then step [302] may be followed by step [310]. As shown, at step [310], the non-domain-specific query may be directly processed using the associated AI models by the intelligent interaction unit [204]. To illustrate, continuing with the above example, in one implementation, the intelligent interaction unit [204] may perform a real-time speech-to-text operation on the language audio associated with a content being displayed on the computing device [220] of the user. Thereafter, one or more large language models (LLMs) may be used to generate real-time translations of the text in preferred language of the user. It may be noted that the above functionality is exemplary in nature and not intended to limit the scope of operations that may be performed at step [310]. As such, it may be understood by a person ordinarily skilled in that that the intelligent interaction unit [204] may perform other functions, as required, on the basis of one or more input queries.

Thereafter, at step [312], the one or more responses generated from the processing of the non-domain-specific queries may be presented to the user, via an intelligent interaction service of the intelligent interaction unit [204], on the computing device [220] of the user.

As used herein, an intelligent interaction service may comprise an intelligent conversational interface between the system and the computing device that may be used to display the one or more prompts and the one or more responses to the user. Additionally, the intelligent interaction service may also comprise the interface to register the input queries provided by the user, via the computing device [220].

In one implementation, the intelligent interaction service may be an intelligent chatbot. In another implementation, the service may be implemented as multi-input interaction service configured to interact with the user using multiple mediums, such as GUI, text and speech.

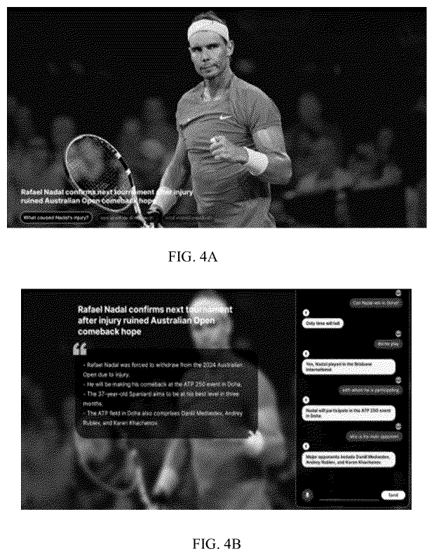

Referring now to FIG. 4A, an exemplary implementation of the display of one or more prompts on the display unit of a computing device [220] is shown. FIG. 4A shows a screen with one or more prompts, preferably contextual prompts, which encourage the user to explore one or more inner screens and discover engaging content. Further as shown, the one or more prompts may be displayed in more than one language that enables the identification of the language preferences of the user to provide personally curated content. Upon capturing user preferences, the user preferences are utilized to shape an entire user flow. The content is delivered in the user's preferred language, and the one or more inner screens are dynamically adapted, including one or more adjustments in voice output to align with their selected preferences.

Further, as shown, using context, the one or more prompts incite the user engage with the content by presenting one or more questions to the user that are related with the on-screen content. In one implementation, when the user selects the one or more prompts, one or more responses may be generated and displayed to the user.

In one exemplary implementation, a condensed summary may be generated, highlighting the key points for quick and easy perusal by the user. If users desire more information, the user is permitted to ask one or more questions related to the summary to receive detailed answers as depicted in FIG. 4B. In another exemplary implementation, any questions outside the context may be disregarded.

Referring now to FIG. 4B, an exemplary view of the one or more responses in accordance with an exemplary implementation is shown. As shown, the one or more responses may be displayed in a summary format. Further, generation of the one or more responses may be multi-lingual in nature. For example, as shown, the contents of the summary format are displayed in English as an outcome of the determined user preference via the selection of the one or more prompt in English. Alternatively, based on the user preferences, the one or more responses may be generated in a wide variety of languages thereby increasing accessibility to content and providing a rich user interaction experience. Further, based upon user engagement, wherein a user may be interested in further interaction after the display of the one or more responses, the user may be invited to provide additional one or more input queries to provoke an interactive conversation experience for the user.

The technical solutions in this disclosure propose a novel method and system for providing interactive content experience on at least one computing device. The technical solutions of the present disclosure also provide a technical advancement over the currently known solution. The present solution is able to revolutionize the way television content, encompassing images, videos, documents and audio, is interacted with. By harnessing one or more advanced AI models, either deployed server-side or at the client end, this solution elevates the interactivity of traditional TV content. The present disclosure also has several technical advantages like generation of one or more contextually aware prompts to initiate conversations that may additionally serve to gauge user preferences. This feature enhances the discovery and ease of interaction within the viewing experience of one or more content on a computing device. Unlike conventional approaches that are often integrated with specific show or applications, the system and method of the present disclosure seamlessly integrates with any content that may be viewed by a user. For instance, during a show, the system provides timely prompts related to the topic, sparking engaging conversations among viewers, to ensures adherence to TV restrictions while facilitating two-way conversations in real-time.

Further, unlike the conventional solution in the state of the art, the solution of the present disclosure drastically improves user accessibility via the integration of multi-lingual interaction and real-time translation.

Additionally, by focusing on real-time prompt generation, the present disclosure enhances the immediacy and relevance of interactions, thereby enriching the overall viewing experience. Furthermore, the present disclosure introduces the one or more prompts (i.e. one or more contextual prompts) in various languages, tailored to the on-screen content. The one or more prompts are not just interactive elements but also serve as tools to gauge user language preferences, facilitating a more personalized viewing experience. When a user engages with a prompt, the system uses this interaction to refine future content, ensuring it aligns with their language preferences. Furthermore, the present solution allows the user to engage in contextual conversations through voice or text inputs and the responses are provided in the user's preferred language, both as text and in native language voice accents. This aspect of the solution ensures a personalized and linguistically tailored interactive experience. Furthermore, the present solution introduces the AI assistant unit which acts as a personal assistant, responding to user queries with knowledge derived from LLMs and RAGs implementation on live information to make the responses more accurate.

Further, the solution of the present disclosure is technically advanced over the existing solutions in the scope of the one or more responses. Unlike conventional solutions that are limited to basic tasks and automation within a limited set of languages, the present solution enables the generation of a broad set of responses that include intelligent assistant based functions, awareness of on-screen content, personalisation of content, multi-lingual support and translation, caption generation, context determination, navigating websites and databases to assist users with one or more input queries etc.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

We claim:

1. A method for generating one or more interactive responses for at least one computing device, the method comprising:
generating, by a processing unit, one or more prompts for the at least one computing device;
displaying, by a processing unit, the one or more prompts on a display unit of the at least one computing device;
receiving in real time, by a processing unit, one or more input queries from the at least one computing device;
identifying, by the processing unit, one or more interactive attributes based on one of the one or more input queries and the one or more prompts;
generating dynamically, by the processing unit, one or more responses to the one or more input queries based on the one or more interactive attributes; and
displaying, by the processing unit, the one or more responses at the display unit of the at least one computing device.

2. The method as claimed in claim 1, the method further comprising displaying the one or more prompts in one or more languages on the display unit of the at least one computing device.

3. The method as claimed in claim 1, wherein the one or more prompts are generated based on at least one of a user preference and one or more contents being presented at the display unit of the at least one computing device.

4. The method as claimed in claim 1, the method further comprising receiving, at the processing unit, a selection from the at least one computing device from the one or more prompts displayed at the display unit of the at least one computing device, wherein the one or more attributes are identified based on an analysis of the received selection.

5. The method as claimed in claim 1, wherein the one or more interactive attributes comprises one of a language, an accent and one or more tasks associated with the one or more input queries.

6. The method as claimed in claim 1, the method further comprising transmitting, by the processing unit, the one or more interactive attributes to an intelligent interaction unit connected with a multilingual repository, and wherein the intelligent interaction unit generates the one or more responses.

7. A system for generating one or more interactive responses for at least one computing device, the system comprising a processing unit connected to a memory, said processing unit configured to:
generate one or more prompts for the at least one computing device;
display the one or more prompts on a display unit of the at least one computing device;
receive one or more input queries from the at least one computing device;
identify one or more interactive attributes based on one of the one or more input queries and the one or more prompts;
generate dynamically one or more responses to the one or more input queries based on the one or more attributes; and
display the one or more responses at the display unit of the at least one computing device.

8. The system as claimed in claim 7, wherein the system is further configured to display the one or more prompts in one or more language on the display unit of the at least one computing device.

9. The system as claimed in claim 7, wherein the processing unit is further configured to generate the one or more prompts based on at least one of a user preference and one or more contents being presented at the display unit of the at least one computing device.

10. The system as claimed in claim 7, wherein the processing unit is further configured to receive a selection from the at least one computing device from the one or more prompts displayed at the display unit of the at least one computing device, and wherein the one or more attributes are identified based on an analysis of the received selection.

11. The system as claimed in claim 7, wherein the one or more interactive attributes comprises one of a language, an accent and one or more tasks associated with the one or more input queries.

12. The system as claimed in claim 7, the system further comprising an intelligent interaction unit connected with a multilingual repository, said intelligent interaction unit configured to receive the one or more interactive attributes from the processing unit and generate the one or more responses.
